(19) United States
(12) Patent Application Publication
(10) Pub. No.: US 2025/0117922 A1
(43) Pub. Date: Apr. 10, 2025

(54) DEFECT DETECTION METHOD, DEFECT DETECTION DEVICE, AND STORAGE MEDIUM

(71) Applicant: HON HAI PRECISION INDUSTRY CO., LTD., New Taipei (TW)

(72) Inventor: CHIH-YUAN CHUANG, New Taipei (TW)

(21) Appl. No.: 18/518,512

(22) Filed: Nov. 23, 2023

(30) Foreign Application Priority Data
Oct. 7, 2023 (CN) 202311287786.5

(51) Int. Cl. G06T 7/00

(52) U.S. Cl. CPC G06T 7/0008; G06T 2207/20084

(57) ABSTRACT

The present application provides a defect detection method. The method includes obtaining a first image of a product and a first defect detection result of the first image. The product is cleaned, and a second image of the product is obtained after the product has been cleaned. Once a second defect detection result of the second image is obtained, a third defect detection result of the product is determined based on the first defect detection result and the second defect detection result.

### FIELD

The present application relates to the field of product detection technology, and particular to a defect detection method, a defect detection device, and a storage medium.

### BACKGROUND

Defects on a surface of a product not only destroy the product's beauty and comfort, but may also cause serious damage to the product's performance. In related technologies, when detecting defects based on images of the product, dirt on the surface of the product may be misjudged as defects, resulting in a reduction in the accuracy of detecting defects of the product.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a structural diagram illustrating a defect detection device provided by an embodiment of the present application.

FIG. 2 is a flow chart illustrating a defect detection method provided by an embodiment of the present application.

FIG. 3 is an example diagram illustrating a transmission environment of a product transmitting between devices according to an embodiment of the present application.

FIG. 4 is an example diagram illustrating a first position provided by an embodiment of the present application.

FIG. 5 is an example diagram illustrating a first defect detection result and a second defect detection result provided by an embodiment of the present application.

FIG. 6 is an example diagram illustrating a first defect detection result and a second defect detection result provided by another embodiment of the present application.

FIG. 7 is an example diagram illustrating a first defect detection result and a second defect detection result provided by another embodiment of the present application.

FIG. 8 is an example diagram illustrating a first defect detection result and a second defect detection result provided by another embodiment of the present application.

FIG. 9 is a structural diagram illustrating a defect detection system provided by an embodiment of the present application.

### DETAILED DESCRIPTION

In order to more clearly understand the above objects, features and advantages of the present application, the present application will be described in detail below in conjunction with the accompanying drawings and specific embodiments. It should be noted that, in the case of no conflict, the embodiments of the present application and the features in the embodiments can be combined with each other.

Unless otherwise defined, all technical and scientific terms used herein have the same meaning as commonly understood by one of ordinary skill in the technical field to which this application belongs. The terms used herein in the specification of the application are only for the purpose of describing specific embodiments, and are not intended to limit the application.

It should be noted that “at least one” in this application refers to one or more, and “a plurality of” refers to two or more than two. “And/or” describes the association of associated objects, indicating that there can be three relationships. For example, A and/or B can mean: A exists alone, A and B exist simultaneously, and B exists alone, where A, B can be singular or plural. The terms “first”, “second”, “third”, “fourth”, etc. (if present) in the description, claims and drawings of this application are used to distinguish similar objects, rather than to describe a specific order or sequence.

In the embodiments of the present application, it should be noted that, unless otherwise explicitly stated or limited, words such as “exemplary” or “for example” are used to represent examples, illustrations or explanations. Any embodiment or design described as “exemplary” or “for example” in the embodiments of the present application is not to be construed as preferred or advantageous over other embodiments or designs. Rather, use of words such as “exemplary” or “for example” is intended to present related concepts in a concrete manner. In the case of no conflict, the following embodiments and features in the embodiments can be combined with each other.

In one embodiment, surface defects of a product not only destroy the beauty and comfort of the product, but may also cause serious damage to the performance of the product. In related technologies, when detecting defects based on images of products. dirt on the surface of the product may be misjudged as defects, resulting in a reduction in the accuracy of defect detection of the product.

In order to solve the above problems, embodiments of the present application provide a defect detection method. First, a first image of a product to be detected and a first defect detection result of the first image are obtained; and then, in order to determine whether a defect present in the first defect detection result is a dirty on a surface of the product, the product to be detected is cleaned and a second image of the product to be detected and a second defect detection result of the second image are obtained; then based on the first defect detection result and the second defect detection result, a third defect detection result of the product to be detected is determined, a dirty on the surface of the product can be avoided to be misjudged as a defect of the product, and the accuracy of product defect detection can be improved.

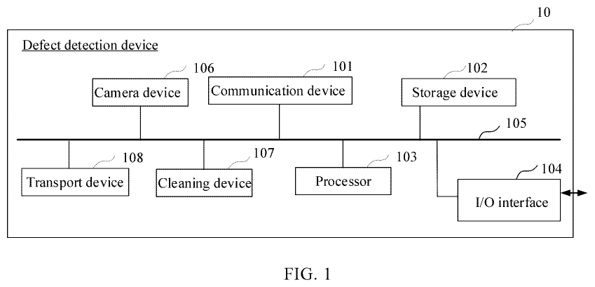

FIG. 1 is a schematic structural diagram of a defect detection device provided by an embodiment of the present application. The embodiment of the present application does not place any restrictions on the specific type of the defect detection device.

As shown in FIG. 1, the defect detection device 10 may include a communication device 101. a storage device 102, a processor 103, an input/output (I/O) interface 104, and a bus 105. The processor 103 is coupled to the communication device 101, the storage device 102, the I/O interface 104, at least one camera device 106, a cleaning device 107. and a transport device 108 through the bus 105.

The communication device 101 may include a wired communication device and/or a wireless communication device. The wired communication device can provide one or more wired communication solutions such as universal serial bus (USB) and controller area network (CAN). The wireless communication device can provide one or more wired communication solutions such as wireless fidelity (Wi-Fi), Bluetooth (BT), mobile communication network, frequency modulation (FM), near field communication (NFC), infrared (IR) technology.

The storage device 102 may include one or more random access memories (RAM) and one or more non-volatile memories (NVM). The random access memories can be directly read and written by the processor 103, can be used to store executable programs (such as computer readable instructions) of the operating system or other running programs, and can also be used to store user data and application data. etc. The random access memories can include static random-access memory (SRAM), dynamic random access memory (DRAM), synchronous dynamic random access memory (SDRAM), double data rate synchronous Dynamic random access memory (DDR SDRAM), etc.

The non-volatile memories can also store executable programs and user data and application data, etc., and can be loaded into the random access memory in advance for direct reading and writing by the processor 110. The non-volatile memories can include disk storage devices and flash memories.

The storage device 102 is used to store one or more computer programs. The one or more computer programs are configured for execution by processor 103. The one or more computer programs include a plurality of instructions. When the plurality of instructions is executed by the processor 103, the defect detection method executed on the defect detection device 10 can be implemented.

In other embodiments, the defect detection device 10 further includes an external storage device interface for connecting to an external storage device to expand a storage capacity of the defect detection device 10.

The processor 103 may include one or more processing units. For example, the processor 103 may include an application processor (AP), a modem processor, a graphics processing unit (GPU), and an image signal processor (ISP), a controller, a video codec, a digital signal processor (DSP), a baseband processor, and/or a neural network processing unit (NPU), etc. Among them, different processing units can be independent devices or integrated in one or more processors.

The processor 103 provides computing and control capabilities. For example, the processor 103 is used to execute a computer program stored in the storage device 102 to implement the above-mentioned defect detection method.

The I/O interface 104 is used to provide a channel for user input or output. For example, the I/O interface 104 can be used to connect various input and output devices, such as a mouse, a keyboard, a touch device, a display screen, etc., so that the user can input information or visualize information.

The bus 105 is at least used to provide a communication channel between the communication device 101, the storage device 102, the processor 103, the I/O interface 104, the camera device 106, the cleaning device 107, and the transport device 108 in the defect detection device 10.

The camera device 106 is used to take images of the product; the cleaning device 107 is used to clean the product. The cleaning device 107 can include cleaning devices (such as electrostatic brushes, high-pressure air guns) corresponding to various production processes; the transport device 108 is used to move the product between a location where the camera device 106 is located and a location where the cleaning device 107 is located. For example, the transport device 108 may include, but is not limited to, a conveyor belt, a robotic arm, etc.

It can be understood that the structure illustrated in the embodiment of the present application does not constitute a specific limitation on the defect detection device 10. In other embodiments of the present application, the defect detection device 10 may include more or less components than shown in the figures, or combine some components, or split some components, or arrange different components. The components illustrated may be implemented in hardware, software, or a combination of software and hardware.

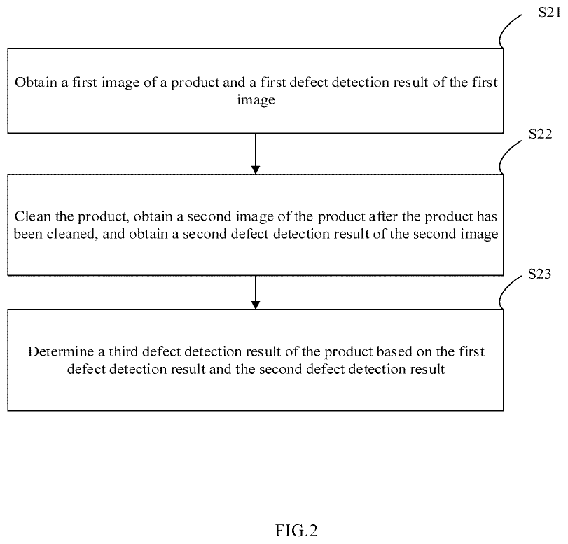

FIG. 2 is a flow chart of a defect detection method provided by an embodiment of the present application. The defect detection method is applied to a defect detection device, such as the defect detection device 10 in FIG. 1, and specifically includes the following blocks. According to different needs, the order of the blocks in the flow chart can be changed, and some of them can be omitted.

Block S21, the defect detection device obtains a first image of a product and a first defect detection result of the first image.

In one embodiment, the product needs to be detected and the product can be any product produced in a factory that needs to be detected for defects. For example, the product can be a specification for a cosmetic containing text or images, or the product can be a metal plate, etc. The defects of the products to be detected may include defects of various categories, such as a category of incomplete text, a category of surface scratching, a category of surface cracking, etc. In addition, since vacuum cannot be achieved during a production process of the product, the surface of the product may be contaminated by dirt (such as dust, lint) floating in a production environment, causing defects of the product including dirt on a surface (hereinafter “surface dirt) of the product. Since the surface dirt is a defect that can be removed by cleaning, the surface dirt can be regarded as a non-substantial defect. and the non-surface dirt can be regarded as a substantial defect. That is, the defects of the product can include defects of two categories, namely the non-substantial defect and the substantial defect.

In one embodiment, a transport device of the defect detection device (such as the transport device 108 shown in FIG. 1) can be used to move the product to the location of a camera device (such as the camera device 106 shown in FIG. 1), and the first image of the product can be obtained by capturing the product using the camera device.

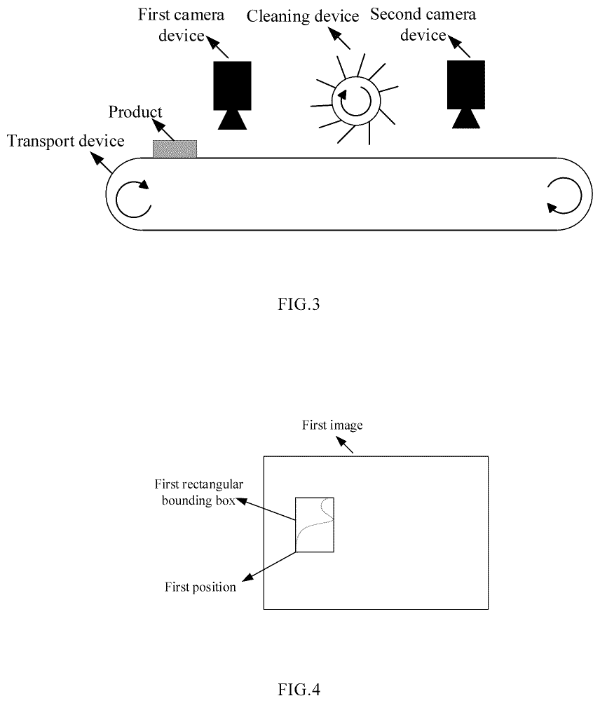

For example, as shown in FIG. 3, the transport device can be a conveyor belt, and a plurality of sensors (such as pressure sensors, infrared sensors, etc.) can be installed on both sides of the transport device; when the sensor detects that the product to be detected has been placed on the conveyor belt, the defect detection device controls the conveyor belt to transport the product to the location of the camera device (such as a first camera device shown in FIG. 3), and uses the camera device to capture the product to obtain the first image.

In one embodiment, in order to improve the accuracy of defect detection on the first image, before performing defect detection on the first image, the defect detection device further: performs a preprocessing on the first image, and the preprocessing including but is not limited to, adjusting a size of the first image, for example, adjusting the size of the first image to a predetermined size required by a defect detection model; performs an image optimization on the first image, for example, upgrades a texture clarity of the first image by adjusting the texture clarity of the first image based on an interpolation algorithm (such as a bilinear interpolation algorithm); performs a grayscale processing on the first image. such as converts the first image into a grayscale image using a weighted average method; performs a filtering processing on the first image, such as removes noise of the first image using a preset filter (such as mean filter, median filter, etc.) to smooth the first image.

In one embodiment, the defect detection device obtains the first defect detection result by: obtaining the first defect detection result by performing a defect detection on the first image using a pre-trained defect detection model. The first defect detection result may include whether a first defect exists in the first image, and a category (hereinafter “defect category”) of the first defect when the first defect exists in the first image.

In one embodiment, the pre-trained defect detection model may be a deep learning network model based on a semantic segmentation algorithm.

In one example, the pre-trained defect detection model can be a defect detection model based on a fully convolutional neural network (FCN). Specifically, an ordinary convolutional neural networks (CNN) uses a convolutional layer to extract image features of an input image, uses a pooling layer to down sample the image features extracted by the convolutional layer to retain important features and reduce data dimension, uses a fully connected layer to activate an output of the convolution layer and the pooling layer using an activation function (for example, sigmoid, softmax, etc.) to obtain a classification result of the image features. Compared with CNN, FCN replaces the fully connected layer at the end of CNN with a convolutional layer. FCN can accept the first image of any size and output a first feature map with a same size as the first image input into FCN. Each pixel in the first feature map has a corresponding defect detection result of semantic segmentation, thereby obtaining the first defect detection result of the first image. The defect detection result of each pixel may include whether it is a defective pixel and a corresponding defect category. For example, a certain pixel in the first image is a defective pixel, and the defect category corresponding to the defective pixel is the category of surface scratching. When there is the defective pixel in the first image, the first defect detection result of the first image indicates that the first image exists defects; when there is no defective pixel in the first image, the first defect detection result of the first image indicates that the first image does not exist defects.

In another example, the pre-trained defect detection model can be a defect detection model based on an encoder and a decoder. Specifically, detecting defects on the first image using the defect detection model based on the encoder and the decoder includes: extracting low-dimensional features of the first image using a plurality of convolutional layers and a plurality of pooling layers alternately distributed in the encoder; obtaining the first defect detection result of the first image by restoring the low-dimensional features to the same size as the first image through performing a deconvolution and an up-sampling on the low-dimensional features using the decoder. Among them, a network structure of the decoder includes a plurality of convolutional layers and a plurality of pooling layers alternately distributed opposite to a network structure of the encoder. A U-Net structure can also be used to apply a size result generated during tan encoding process of the encoder to a decoding process of the decoder to improve a stability of the decoding process.

In another example, the pre-trained defect detection model can be a defect detection model based on a segmentation network. A model structure of the defect detection model based on the segmentation network includes a two-stage network structure composed of a segmentation network and a decision network. Specifically, a front of the network structure of the segmentation network is similar to a structure of the ordinary CNN mentioned above. In a last convolution layer, a convolution kernel of a preset size (for example, 1×1×1024) is used to reduce a dimensionality of feature extraction results with higher-dimensional (for example, 1024 sets of feature extraction results) of a penultimate convolutional layer to one dimension, thereby obtaining a feature image (for example, the mask image) of defect features in the first image, and then the segmentation network uses the pooling layer to fuse and reduce a dimensionality of the feature image output by the convolution layer to obtain a more concise feature representation; the decision network receives an output result of the segmentation network and performs a global max pooling and an average pooling on the output result, among them. the global max pooling extracts the most likely area of defects in the first image, an average defect probability of each pixel in the first image can be obtained based on the average pooling, and processing results of the global max pooling and the average pooling are combined to calculate the first defect detection result of the first image.

In other examples. a skip connection mechanism can also be used to directly connect outputs of different layers of the defect detection model, allowing information to flow more freely in the network of the defect detection model to help the network better learn and understand features of input data to solve the problems of gradient disappearance and gradient explosion in long sequence data processing. For example, the skip connection mechanism may include but is not limited to, a residual connection or a long short-term memory network (LSTM) structure.

In one embodiment, taking the defect detection model based on segmentation network as an example, the defect detection device trains the defect detection model by: obtaining a sample set, the sample set including training data for defect segmentation (hereinafter “defect segmentation training data”), training data for defect decision-making (hereinafter “defect decision-making training data”), and test data; obtaining a segmentation model used to identify and segment defects in an image by training an initial segmentation model using the defect segmentation training data; obtaining a decision-making model used to classify defects according to characteristics of the defects by training an initial decision-making model using the defect decision-making training data; obtaining a trained defect detection model by combining the segmentation model and the decision-making model; testing the trained defect detection model using the test data and a preset loss function to verify an accuracy and a precision of the trained defect detection model; if the accuracy or the precision is less than a corresponding preset threshold, adjusting model parameters (such as a learning rate, an optimizer, a loss function, etc.) and repeating the above process until obtaining a defect detection model whose accuracy and precision not less than corresponding preset thresholds.

In one embodiment, the defect detection device further: determines a first position where a first defect is located when the first defect detection result indicates that the first defect exists in the first image. Specifically, the defect detection device can generate a first rectangular bounding box for the first defect (for example, as shown in FIG. 4), and determines a position of any corner point or a position of a center point of the first rectangular bounding box as the first position of the first defect (for example, as shown in FIG. 4).

In one embodiment, the defect detection device can establish a first coordinate system by setting a lower left corner of the first image as a coordinate origin of the first coordinate system, setting a straight line where a long side of the first image is located as an horizontal axis of the first coordinate system and setting a straight line where a broad side of the first image is located as a vertical axis of the first coordinate system, and setting a size of one pixel as a unit length of the first coordinate system, thereby determining a first coordinate of the first position in the first coordinate system.

Block S22, the defect detection device cleans the product, obtains a second image of the product after the product has been cleaned, and obtains a second defect detection result of the second image.

In one embodiment, in order to determine whether the defect indicated by the first defect detection result is a substantial defect, the defect detection device can clean the product using the cleaning device 107. The cleaning of the product includes determining a cleaning process corresponding to a production process of the product, and cleaning the product according to the cleaning process. For example, when there is dust in the environment of the production process of the product, the defect detection device can determine a high-pressure air gun can be used in the cleaning process. When there is lint and dust in the environment of the production process of the product, the defect detection device can determine an electrostatic brush can be used in the cleaning process.

In one embodiment, for example, as shown in FIG. 3, a transport device can be used to move the product from the location where the camera device that captured the first image (such as the first camera device shown in FIG. 3) is located to the location where the corresponding cleaning device is located. After the product has been cleaned, the defect detection device can move the product from the location of the cleaning device to the location of the camera device (such as the second camera device shown in FIG. 3) using the transport device, and can control the camera device to capture the product to obtain the second image of the product when the product is moved back to the location of the camera device.

In one embodiment, before performing defect detection on the second image, the defect detection device further performs a preprocessing on the second image as described in block S21, and obtains a preprocessed second image of which a size is the same as the size of the first image after the preprocessing has been performed, and the product in the preprocessed second image has the same size and position as the product before cleaning in the first image.

In one embodiment, the defect detection device obtains the second defect detection result of the second image by: using the defect detection model as described in block S21 to perform defect detection on the second image to obtain the second defect detection result.

In one embodiment, the defect detection device further: determines a second position where a second defect is located when the second defect detection result indicates that the second defect exists in the second image. Specifically, the defect detection device can generate a second rectangular bounding box for the second defect, and determine a position of any corner point or a center point of the second rectangular bounding box as the second position where the second defect is located. The method of determining the second position is the same as the method of determining the first position. For example, if the center point of the first rectangular bounding box is determined as the first position, then the center point of the second rectangular bounding box is determined as the second position. If an upper left corner point of the first rectangular bounding box is determined as the first position, then an upper left corner point of the second rectangular bounding box is determined as the second position. For example, the defect detection device can establish a second coordinate system by setting a lower left corner of the second image as a coordinate origin of the second coordinate system, setting a straight line where a long side of the second image as a horizontal axis of the second coordinate system and setting a straight line where a wide side of the second image as a vertical axis of the second coordinate system, and setting a size of one pixel as a unit length of the second coordinate system, thereby determining a second coordinate of the second position in the second coordinate system.

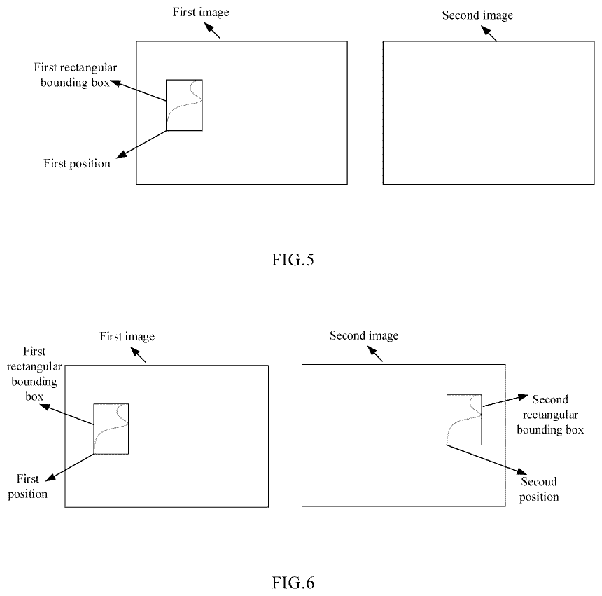

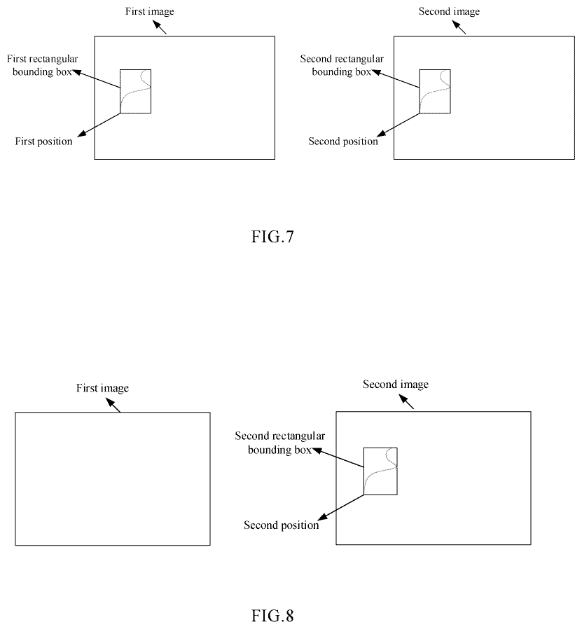

Block S23, the defect detection device determines a third defect detection result of the product based on the first defect detection result and the second defect detection result.
In one embodiment, the defect detection device determines the third defect detection result of the product by:
When the first defect exists in the first image and the second defect does not exist in the second image, determining that the first defect is surface dirt, and determining that the third defect detection result including that there is no substantial flaw on the product (for example, as shown in FIG. 5); or
When the first position of the first defect is different from the second position of the second defect, determining that both the first defect and the second defect are surface dirt, and determining that the third defect detection result including that there is no substantial flaw on the product (For example, as shown in FIG. 6); or
When the first position is the same as the second position, determining that the third defect detection result including that there is a substantial flaw on the product (for example, as shown in FIG. 7); or
When the first defect does not exist in the first image and the second defect exists in the second image, determining that the second defect is surface contamination. and determining that the third defect detection result including that there is no substantial flaw on the product (for example, as shown in FIG. 8).

In one embodiment, when the first defect does not exist in the first image and the second defect does not exist in the second image, the defect detection device determines that the third defect detection result includes that there is no substantial defect.

In one embodiment, when determining whether the first position is same as the second position, the defect detection device can calculate a Euclidean distance between the first coordinate and the second coordinate. When the Euclidean distance is equal to 0, the defect detection device can determine that the first position is same as the second position; or when the Euclidean distance is not equal to 0. the defect detection device can determine that the first position is different from the second position.

In one embodiment, after the third defect detection result of the product is determined, the defect detection device further: sends the first image. the second image, the first defect detection result, the second defect detection result, and the third defect detection result to a user responsible for the product, and receives a re-inspection result of the user inspecting the product, the re-inspection result indicates that whether the third defect detection result is accurate.

In one embodiment. the defect detection method provided by the embodiment of the present application utilizes the characteristic that non-substantial defects can move under an action of an external force, and takes two images of the product. No cleaning process is performed before taking the first image. After taking the first image, the first defect detection result is obtained by determining whether the first defect exists and then clean the product; take the second image of the product and the defect detection result is obtained by determining whether the second defect exist; compare the two defect detection results, if the defect position of the second defect has shifted or disappeared compared with the defect position of the first defect, determines the defect as non-substantive defect with surface dirt, thereby avoiding misjudgment to improve the accuracy of defect detection. In addition, there is no need to use expensive cleaning devices such as a negative pressure chamber equipment to clean the product before detecting the product for defects, reducing the cost of defect detection.

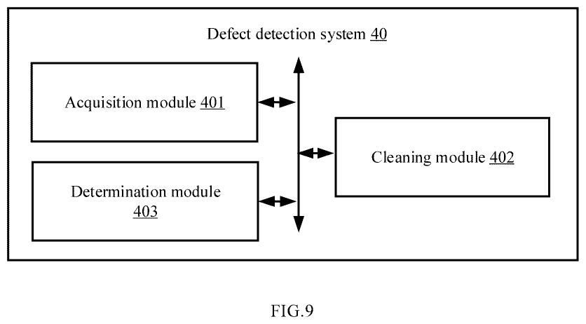

FIG. 9 is a structural diagram of a defect detection system provided by an embodiment of the present application.

In some embodiments, the defect detection system 40 may include a plurality of functional modules composed of computer program segments. The computer program of each program segment in the defect detection system 40 can be stored in the storage device of the defect detection device and executed by at least one processor to perform the function of defect detection (see FIG. 2 for details).

In this embodiment, the defect detection system 40 can be divided into a plurality of functional modules according to the functions it performs. The functional modules may include: an acquisition module 401. a cleaning module 402, and a determination module 403. The module referred to in this application refers to a series of computer program segments that can be executed by at least one processor and can complete a fixed function, which are stored in the storage device. In this embodiment, regarding the functional implementation of each module in the defect detection system 40, please refer to the above limitations on the defect detection method, and the description will not be repeated here.

The acquisition module 401 is used to obtain the first image of the product and the first defect detection result of the first image.

The cleaning module 402 is used to clean the product, and obtain the second image of the product after the product has been cleaned and obtain the second defect detection result of the second image.

The determination module 403 is used to determine the third defect detection result of the product based on the first defect detection result and the second defect detection result.

Embodiments of the present application also provide a computer-readable storage medium. A computer program is stored on the computer-readable storage medium. The computer program includes program instructions. The method implemented when the program instructions are executed may refer to the methods in each of the above embodiments.

The computer-readable storage medium may be an internal storage device of the defect detection device described in the above embodiment. such as a hard disk or a memory of the defect detection device. The computer-readable storage medium may also be an external storage device of the defect detection device, such as a plug-in hard disk, a smart media card (SMC), a secure digital (SD) card, or a flash card equipped on the defect detection device.

In some embodiments, the computer-readable storage medium may include a storage program area and a storage data area, wherein the storage program area may store an operating system, at least one application program required for a function, etc.; the storage data area may store data created based on the use of the defect detection device.

In the above embodiments, each embodiment is described with its own emphasis. For parts that are not detailed or documented in a certain embodiment, please refer to the relevant descriptions of other embodiments.

Those of ordinary skill in the art will appreciate that the units and algorithm blocks of each example described in conjunction with the embodiments disclosed herein can be implemented with electronic hardware, or a combination of a computer software and electronic hardware. Whether these functions are performed in hardware or software depends on the specific application and design constraints of the technical solution. Skilled artisans may implement the described functionality using different methods for each specific application. but such implementations should not be considered beyond the scope of this application.

In the embodiments provided in this application, it should be understood that the disclosed devices/terminal devices and methods can be implemented in other ways. For example, embodiments of the devices/terminal devices described above are only illustrative. For example, a division of modules or units is only a logical function division. In actual implementation. there may be other division methods, such as multiple units or components can be combined or can be integrated into another system, or some features can be omitted, or not implemented. On the other hand, the coupling or direct coupling or communication connection between each other shown or discussed may be through some interfaces, indirect coupling or communication connection of devices or units, which may be in electrical, mechanical or other forms.

The units described as separate components may or may not be physically separated, and the components shown as units may or may not be physical units, that is, they may be located in one place, or they may be distributed to multiple network units. Some or all of the units can be selected according to actual needs to achieve the purpose of the solution of this embodiment.

The above described embodiments are only used to illustrate the technical solutions of the present application, but not to limit them; although the present application has been described in detail with reference to the foregoing embodiments. those of ordinary skill in the art should understand that they can still implement the above mentioned implementations. The technical solutions described in the examples are modified, or some of the technical features are equivalently replaced; and these modifications or substitutions do not cause the essence of the corresponding technical solutions to deviate from the spirit and scope of the technical solutions in the embodiments of this application, and should be included in within the protection scope of this application.

What is claimed is:

1. A defect detection method, comprising:
obtaining a first image of a product and a first defect detection result of the first image;
cleaning the product, obtaining a second image of the product after the product has been cleaned, and obtaining a second defect detection result of the second image; and
determining a third defect detection result of the product based on the first defect detection result and the second defect detection result.

2. The defect detection method according to claim 1, further comprising:
determining a first position where a first defect is located when the first defect detection result indicates that the first defect exists in the first image; and
determining a second position where a second defect is located when the second defect detection result indicates that the second defect exists in the second image.

3. The defect detection method according to claim 2, wherein determining the third defect detection result of the product based on the first defect detection result and the second defect detection result comprises:
in response that the first defect exists in the first image and the second defect does not exist in the second image, determining that the first defect is surface dirt, and determining that there is no substantial flaw on the product; or
in response that the first position of the first defect is different from the second position of the second defect, determining that both the first defect and the second defect are surface dirt, and determining that there is no substantial flaw on the product; or
in response that the first position is the same as the second position, determining that there is a substantial flaw on the product; or
in response that the first defect does not exist in the first image and the second defect exists in the second image, determining that the second defect is surface contamination, and determining that there is no substantial flaw on the product.

4. The defect detection method according to claim 1, wherein cleaning the product comprises:
determining a cleaning process corresponding to a production process of the product, and cleaning the product according to the cleaning process.

5. The defect detection method according to claim 1, wherein the first defect detection result of the first image is obtained by:
obtaining the first defect detection result by performing a defect detection on the first image using a pre-trained defect detection model.

6. The defect detection method according to claim 5, wherein the pre-trained defect detection model is a defect detection model based on a segmentation network, and a model structure of the defect detection model based on the segmentation network comprises a two-stage network structure composed of the segmentation network and a decision network.

7. The defect detection method according to claim 5, wherein the pre-trained defect detection model is selected from a defect detection model based on a fully convolutional neural network, and a defect detection model based on an encoder and a decoder.

8. A defect detection device, comprising:
at least one camera device;
a cleaning device;
at least one processor; and
a storage device storing one or more programs, which when executed by the at least one processor, causing the at least one processor to:
obtain a first image of a product using the at least one camera device and obtain a first defect detection result of the first image;
clean the product using the cleaning device, obtain a second image of the product using the at least one camera device after the product has been cleaned, and obtain a second defect detection result of the second image; and
determine a third defect detection result of the product based on the first defect detection result and the second defect detection result.

9. The defect detection device according to claim 8, wherein the at least one processor is further caused to:
determine a first position where a first defect is located when the first defect detection result indicates that the first defect exists in the first image; and
determine a second position where a second defect is located when the second defect detection result indicates that the second defect exists in the second image.

10. The defect detection device according to claim 9, wherein the at least one processor determines the third defect detection result of the product based on the first defect detection result and the second defect detection result by:
in response that the first defect exists in the first image and the second defect does not exist in the second image, determining that the first defect is surface dirt, and determining that there is no substantial flaw on the product; or
in response that the first position of the first defect is different from the second position of the second defect, determining that both the first defect and the second defect are surface dirt, and determining that there is no substantial flaw on the product; or
in response that the first position is the same as the second position, determining that there is a substantial flaw on the product; or
in response that the first defect does not exist in the first image and the second defect exists in the second image, determining that the second defect is surface contamination, and determining that there is no substantial flaw on the product.

11. The defect detection device according to claim 8, wherein the at least one processor cleans the product by:
determining a cleaning process corresponding to a production process of the product, and cleaning the product according to the cleaning process.

12. The defect detection device according to claim 8, wherein the at least one processor obtains the first defect detection result of the first image by:
obtaining the first defect detection result by performing a defect detection on the first image using a pre-trained defect detection model.

13. The defect detection device according to claim 12, wherein the pre-trained defect detection model is a defect detection model based on a segmentation network, and a model structure of the defect detection model based on the segmentation network comprises a two-stage network structure composed of the segmentation network and a decision network.

14. The defect detection device according to claim 12, wherein the pre-trained defect detection model is selected from a defect detection model based on a fully convolutional neural network, and a defect detection model based on an encoder and a decoder.

15. A non-transitory storage medium having programs stored thereon, when the programs are executed by a processor of a defect detection device, the processor is caused to perform a defect detection method, wherein the method comprises:
obtaining a first image of a product and a first defect detection result of the first image;
cleaning the product, obtaining a second image of the product after the product has been cleaned, and obtaining a second defect detection result of the second image; and
determining a third defect detection result of the product based on the first defect detection result and the second defect detection result.

16. The non-transitory storage medium according to claim 15, wherein the method further comprises:
determining a first position where a first defect is located when the first defect detection result indicates that the first defect exists in the first image; and
determining a second position where a second defect is located when the second defect detection result indicates that the second defect exists in the second image.

17. The non-transitory storage medium according to claim 16, wherein determining the third defect detection result of the product based on the first defect detection result and the second defect detection result comprises:
in response that the first defect exists in the first image and the second defect does not exist in the second image, determining that the first defect is surface dirt, and determining that there is no substantial flaw on the product; or
in response that the first position of the first defect is different from the second position of the second defect, determining that both the first defect and the second defect are surface dirt, and determining that there is no substantial flaw on the product; or
in response that the first position is the same as the second position, determining that there is a substantial flaw on the product; or
in response that the first defect does not exist in the first image and the second defect exists in the second image, determining that the second defect is surface contamination, and determining that there is no substantial flaw on the product.

18. The non-transitory storage medium according to claim 15, wherein cleaning the product comprises:
determining a cleaning process corresponding to a production process of the product, and cleaning the product according to the cleaning process.

19. The non-transitory storage medium according to claim 15, wherein the first defect detection result of the first image is obtained by:
obtaining the first defect detection result by performing a defect detection on the first image using a pre-trained defect detection model.

20. The non-transitory storage medium according to claim 19, wherein the pre-trained defect detection model is a defect detection model based on a segmentation network, and a model structure of the defect detection model based on the segmentation network comprises a two-stage network structure composed of the segmentation network and a decision network.
